(19) United States
(12) Patent Application Publication
(10) Pub. No.: US 2005/0151852 A1
(43) Pub. Date: Jul. 14, 2005

(54) Wireless multi-recorder system

(75) Inventor: Jarmo Jomppanen, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/988,205

(22) Filed: Nov. 12, 2004

(30) Foreign Application Priority Data
Nov. 14, 2003 (FI) 20031657

(51) Int. Cl. H04N 5/225; H04N 7/18; H04N 13/02; H04N 15/00; H04N 5/232

(52) U.S. Cl. 348/218.1; 348/159; 348/211.2

(57) ABSTRACT

The invention relates to a method for capturing a target with at least two recorders, in which method at least two recorders are controlled via a wireless connection to capture substantially simultaneously one target common for the recorders or several targets separate for the recorders. The recorders are synchronized to a common reference clock, a triggering message comprising at least a time stamp is transmitted to the recorders via the wireless connection to control the recorders to perform the capturing at the time determined by the time stamp in relation to the common reference clock. The invention relates also to a multi-recorder system, to a terminal and to computer program product.

### CROSS-REFERENCE TO RELATED APPLICATIONS

This application claims priority under 35 USC §119 to Finnish Patent Application No. 20031657 filed on Nov. 14, 2003.

### FIELD OF THE INVENTION

The present invention relates to a capturing of target, and in particular to a capturing of target with more than one recorder.

### BACKGROUND OF THE INVENTION

Capturing targets with a camera has been possible and popular for over a century. The basic principle, function and parts of a camera have remained unchanged over the decades. In a known manner, a camera comprises at least an objective in addition to a body, which objective collects the light reflected by the imaging target and further reflects the target on a film; a view finder, which is a targeting device of the camera and the image shown by it is reflected by the objective to the focusing glass of the camera; a trigger, by pressing which the picture is taken in such a manner that a shutter is opened and light is released to the film; as well as a shutter, which controls the time of exposure of the film. Next to a regular film camera, digital cameras have come to the market, in which cameras the film is replaced with a photosensitive image sensor. This sensor contains several photosensitive diodes, i.e. pixels. The image sensor of a digital camera is usually a CCD (Charge Coupled Device) or CMOS (Complimentary Metal Oxide Semiconductor) sensor. A flow of electric signals travels through the sensor, which flow changed by the software is stored in the often changeable memory unit located in the camera. The storing takes place in digital form, which can be further processed with different apparatuses.

The use of cameras continuously requires new functions to maintain enthusiasm for imaging. Cameras are used more and more in new situations of use, which further creates pressure for renewing working methods. In order for the users to freely adjust the methods of use of a camera, they must be offered examples of the new possibilities of cameras.

One example of the new properties added to a camera has been the autotimer, which has become one of the basic features of a camera. This autotimer has made it possible for the person taking the picture to be the target of imaging himself. The operation of an autotimer is based on delay, which exists between the operation of the trigger and the shutter. The delay has been determined as long enough, so that the person taking the picture can set himself to be imaged. The use of an autotimer has widened the imaging targets so that that the person taking the picture is not cropped outside the image.

Connecting the camera device to other electronic devices, such as a computer (WebCam) or a mobile phone, either as integrated or as a separate device, has been the next step in the development of photography. This development has also created new kind of methods of use for imaging. A mobile phone continuously moving with the user and through it, a camera continuously moving with the user make imaging situations more everyday, natural and spontaneous. This creates new needs and expectations for the functions of cameras.

When familiarizing with camera devices according to prior art, the applicant has not become aware of such camera arrangements that would enable taking several pictures with several storing means as effortlessly and accurately as possible, so that they are taken substantially at the same time in relation to time, in which case spatially at least partially differing images are formed.

Image solutions formed by several cameras are known, for example, from movie making. Several cameras typically shoot one target at the same time. The director determines the takes of the shoot, and it is possible to clap a sound for synchronization with a clapper board, i.e. clapsticks. The cameras can also be connected to a computer, which implements the direction of cameras. However, it is to be noted that this kind of systems are large and complicated solutions and they are usually used only in professional filming situations. In addition, it is to be noted that video filming takes place as a continuous flow, in which case the filming time itself can be independent of other cameras. This means that the start and end time of filming does not necessarily have to match the corresponding ones of another camera. In video filming, the most important thing is that the filming takes place simultaneously at some point.

When filming one specific event, the beginning of the filming, in connection with still-images and short video sequences, has a significantly important role, which makes this type of a camera arrangement very challenging. As an extreme example can be described a situation in a horse show, where a shot of a horse jumping a fence is desired with several cameras. In order for all the cameras to have perfect timing and so that all the cameras would take a picture simultaneously, one of the persons taking the picture should yell “go”, as a result of which the other persons taking the picture would take a picture of the horse with the delay of their own reaction times. As can easily be seen from the example, the imaging situation can have transferred in time between different cameras.

### SUMMARY OF THE INVENTION

The purpose of the present invention is to provide such new way of using recorders, such as a camera, with which is reached such imaging where most persons taking the picture can capture one same target substantially simultaneously. The invention also enables such imaging where several persons taking the picture can capture one different target substantially at the same moment. To put it more precisely, the method according to the present invention is primarily characterized in that the recorders are synchronized to a common reference clock, a triggering message comprising at least a time stamp is transmitted to the recorders via the wireless connection to control the recorders to perform the capturing at the time determined by the time stamp in relation to the common reference clock.

The multi-recording system according to the present invention is primarily characterized in that the system comprises at least synchronizing means for synchronizing the recorders to a common reference clock, control means for transmitting a triggering message comprising at least a time stamp to the recorders via the wireless connection to control the recorders to perform capturing at the time determined by the time stamp in relation to the common reference clock.

The terminal according to the present invention is primarily characterized in that the terminal comprises at least synchronizing means for synchronizing the terminal to a common reference clock shared by the recorders, control means for transmitting a triggering message comprising at least a time stamp to the recorders via the wireless connection to control the recorders to perform capturing at the time determined by said time stamp in relation to the common reference clock.

The recorder unit according to the present invention is primarily characterized in that said unit comprises at least synchronizing means for synchronizing the unit to a common reference clock shared with at least one other device, reception means for receiving via the wireless connection a triggering message that comprises at least a time stamp, and triggering means for capturing the target at the time determined by the time stamp comprised by the triggering message in relation to the common reference clock.

The computer software product according to the present invention is primarily characterized in that said software comprises at least commands for receiving in a recorder via the wireless connection a triggering message comprising at least a time stamp to control the recorder to perform capturing at the time determined by said time stamp in relation to a common reference clock with which the recorders have been synchronized.

The computer software product according to the present invention is primarily characterized in that said software comprises at least commands for transmitting to a recorder via the wireless connection a triggering message comprising at least a time stamp to control the recorder to perform capturing at the time determined by said time stamp in relation to a common reference clock with which the recorders have been synchronized.

Each device taking part in the multi-imaging is arranged in a communication connecting in some known way. This means that the device is arranged to receive a time stamp and to transmit the time stamp, as well as to receive the image and to transmit the image to other devices.

Each device participating in the multi-imaging can be used as the trigger. But at least one of the devices participating in the multi-imaging must be the trigger device. The selection of the trigger can be performed by random selection or according to the need. The triggering can be performed by the user or at a time determined by the system, in which case the device forms a time stamp informing the imaging moment to be transmitted to the devices participating in the multi-imaging.

Each of the one or more devices provided with a camera sensor taking part in the multi-imaging monitors the time stamp, which indicates the imaging moment. The camera sensor is arranged to function when the time stamp set in the device expires.

The device that is arranged at least to gather imaging data stores all the received images with their time stamps. Images that have the same time stamp belong together and they are processed further depending on the application area.

By means of the invention, several recorders are synchronized so that they take the images close enough to each other in time, i.e. substantially simultaneously. For synchronization, it is possible to use existing network-based synchronization methods, but in selecting the method, such a method should be prioritized by means of which the time between the images is the smallest possible. Thanks to this type of a method, the quality of the images improves.

### BRIEF DESCRIPTION OF THE DRAWINGS

The present invention will be described in more detail with reference to the following drawings, in which

FIG. 1 presents one example of an imaging situation,

FIG. 2 visualizes as a block diagram one example of an embodiment of the method,

FIG. 3 presents one example of the device according to the invention as an simplified drawing, and

FIGS. 4a and 4b present some visualizing examples of imaging situations.

### DETAILED DESCRIPTION OF THE INVENTION

The present multicamera system comprises at least two devices, which are provided with software according to the invention, which implements the multi-imaging according to the invention. When discussing the multi-imaging according to the invention, at least two devices provided with a camera sensor belong to the system. It is, however, clear that in some situations only one recorder provided with a camera sensor can be connected to the system, and another device, which does not comprise a camera sensor and which is arranged to control the recorder (by triggering). Examples of the devices are portable terminals capable of communication, such as a mobile phone provided with a camera sensor, or a PDA device (Personal Digital Assistant) or a digital camera, which is connected to communication means. Thus, it should be evident that at least one, but for example two or more devices belonging to the system are to be provided with a camera sensor, or they must be connectable to a camera sensor. An example is a camera phone, which comprises mobile communication means and an integrated digital camera. It should also be evident that the invention can also be applied in connection with other recorders, which can be arranged in a wireless data transfer with each other. An example is a digital camera provided with Bluetooth or other corresponding network technique. As examples of other network techniques can be mentioned SMS (Short Message Service), WAP (Wireless Application Protocol), mobile communication networks, such as GPRS, GSM, WDCMA, UMTS and local area networks, such as a wireless local area network WLAN. In the selection of network technology, the most important issue is to note that between two recorders belonging to a multicamera system it must always be possible to reliably measure the delay forming in data communication and that the same timer can be set for these recorders.

In other words, at least two such devices must belong to a system, which have a possibility for message transmission and of which at least one is provided with a camera sensor. Therefore, such systems where there is, for example, one PDA device and at least one camera phone or a system where there are at least two camera phones, are suitable examples of utilizing the invention.

The devices connect to a multicamera system by using one of the above-mentioned data transfer connections. Connection takes place in such a manner that the devices that have a network connection open and the multi-imaging software running, signal through a network connection and search for other recorders in a corresponding situation. When one or more of this kind of device are detected, they together form a multicamera system and take part in implementing multi-imaging. It is to be noted that all the recorders do not need to be in direct connection with all the other devices, but messages can be transmitted from one recorder to another via a third recorder. As an example is described a data network, where each recorder is in connection with only two adjacent recorders, in which case a ring-like network structure is formed. In this case, data can be transmitted to each device according to the transmitting structure. In other words, one recorder must be able to send a message to one or more other recorders, and in addition, it must also be able to receive a message from one or more recorders.

Connection can also be implemented by a user inputting the connection information of another device to the user's own device, in which case these users can connect to or exchange information on or with other devices known by them. Every time some device adds connection information to its own device, the system also sends the same information to other devices it knows.

It is, in addition possible that a separate server is used in the connection, via which the information is transmitted. By means of the server it is possible to maintain one or more groups that have become organized hierarchically. This type of a solution is simple and suits well for global imaging (example 3b described later). One of the devices can also function as a separate server.

Of the devices belonging to the multicamera system, at least one device is to be arranged as a trigger. It is, however, possible that from time to time all the devices belonging to the system can function as triggers. Such a device that does not comprise a camera sensor can, for example, function as a trigger. Generally, any of the devices belonging to the system can be selected as a trigger and the selection can take place application-specifically according to need or arbitrarily by, for example, drawing lots. The trigger function can take place in the selected device engaged by the user or set by the system at an application-specific moment of time. As a result of triggering, a time stamp is formed in the device in question, which also takes into account the demands of synchronization. After this, the selected device has a new time stamp to be transmitted to the other devices of the system.

Each device taking part in the system comprises means for communicating with other devices. Thus, each device is arranged to transmit and receive data. When receiving a new time stamp X, the receiver must check whether it is worthwhile for it to transmit the received time stamp X further forwards. For this checking, the device has stored a preliminary time stamp E. If the preliminary time stamp E is not set, it is set according to the received time stamp X, E=X. If the preliminary time stamp E is set, its time is checked in relation to the received time stamp X. If the received time stamp X is earlier than the preliminary time stamp E, the time stamp X is destroyed. If the received time stamp X is later than the preliminary time stamp E, the preliminary time stamp E is set according to the received time stamp X, E=X, and the new time stamp is transmitted to other devices.

When the devices have received a time stamp, the multi-imaging according to the invention can be implemented. The recorders synchronized mutually in relation to time take a picture of their own target (which can also be shared by some or all persons taking the picture) substantially simultaneously. The shutter of each recorder is arranged to function as a result of triggering information displayed by the time stamp received from one device. The recorder provided with a camera sensor monitors the time stamp, which indicates the moment of imaging. When the time stamp set to the device expires, the device takes a picture with the camera sensor. In other words, as a result of triggering one device, each recorder provided with a camera sensor in the system takes a picture. With imaging, each recorder that has performed imaging has a new image and the time stamp of the time of the imaging.

These images with their time stamps are transmitted further to that one or more devices that are determined as data collectors. This device can be a recorder provided with a camera sensor or a device without one. Each imaging device transmits its own image with its time stamp to that neighbouring device, which is the closest to the collecting device or to that device, which is predetermined as a receiver. In addition, each imaging device transmits images taken by others with their time stamps closer to the collecting device when said imaging device is between said other device and the collecting device. The device collecting image data stores all the images it has received with their time stamps. Those images that have the same time stamp belong together and they are handled application-specifically. After this the system performs a situation-specific image handling for the images it has taken.

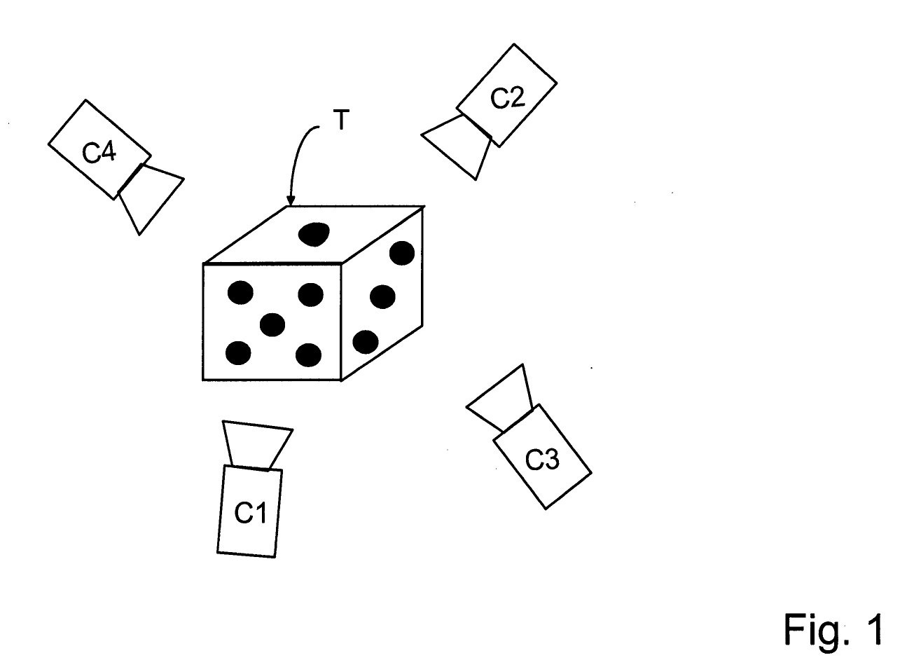

The invention is described by means of yet another imaging situation example, which is presented in FIG. 1. In this situation, four recorders C1, C2, C3, C4 are imaging a target T. Said recorders C1, C2, C3, C4 are in this example camera phones. The recorders can also be separate camera devices, which can be arranged in connection with a mobile phone or some other device capable of communication. Even though each recorder belongs during synchronization to a multicamera system according to the invention, each of them is an individual functional unit in the operation of the entire system. Each unit, i.e. each recorder is in data transfer connection with other units so that one multicamera system is formed of them. Before imaging, the entire multicamera system and through that each unit is in a targeting mode and imaging readiness.

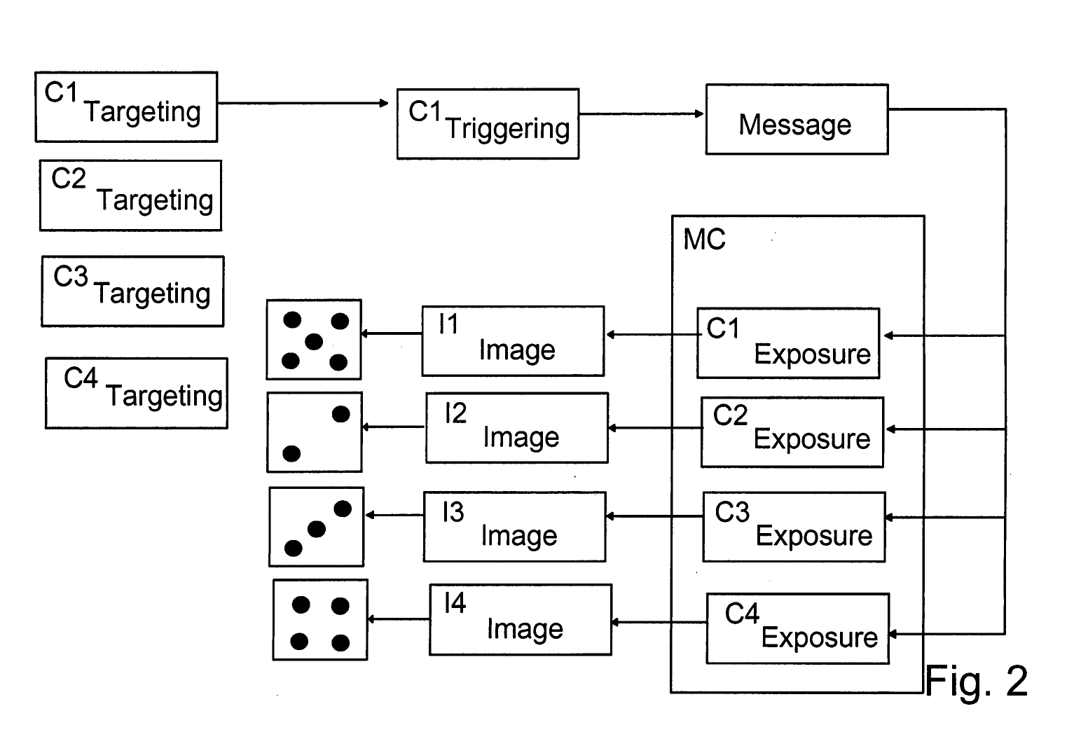

An example of an embodiment of the operation of the invention is presented in the block diagram of FIG. 2. The recorders C1, C2, C3 and C4 search the target T they desire in their focus. If no time stamp has been set for the recorder, it can be triggered; in this example the user of the recorder C1 presses the trigger. As a result of triggering, a message is formed, which comprises a time stamp of the reference time at the moment of triggering, of the maximum delay, i.e. how long sending the message to all recorders according to the synchronization will take at the most, and of the margin of safety (which can also be included in the estimation of maximum delay). In addition to the triggering message, it is possible to send also other information to the recorders about performing the imaging. Said other information can be sent among triggering messages or as a separate message, such as text message (SMS) or the like. The purpose of this information is to give the person taking the picture additional information on the imaging situation, for example in a football game it is possible to transmit the wish to follow a certain player during the game to one person taking a picture.

If more than one device implements the triggering, plural trigger messages are provided for the system. As a result of this, one or more trigger messages arrives at each device at different times, each of which messages contains a time stamp for triggering the camera according to a mutual reference timer. When the recorder has received a time stamp, either from itself or from some other recorder, it sets it as the trigger time and waits until the time stamp expires and takes a picture. If the received time stamp has not expired and some other recorder sends a new time stamp, the set time stamp E and the new time stamp X are compared and the earlier one of these is selected to be set as triggering time. The earlier time stamp E has not expired when the synchronization is formed correctly. Whenever the recorder receives a new time stamp X from some other recorder, it sends it to others. The sending is not performed if the received time stamp X is the same as the already set E. As a result of time stamp transfer, all the recorders have the correct time stamp, even if more than one triggerings were performed. That recorder whose time stamp all have functions as a trigger. It should be evident that in order to decrease communication it is more appropriate that only that one of the devices is selected which performs the first triggering, in which case several overlapping time stamps are avoided. The selection can be implemented in several different ways, but as an example can be mentioned drawing lots (the result of which is reported to the “winner”), selecting directly the first one who opened the system, voting, or by means of a separate device without a camera, which device commands taking pictures every even number of minutes, or some other appropriate time interval, in which case said server is also formed as the specifier of the triggering moment.

Before transmitting the triggering message to other recorders, they are to be in synchronization with each other, so that a substantially simultaneous imaging can be implemented. Here, synchronization means the formation of a common time and latency between the devices. The synchronization can be performed before the imaging begins, for example as a result of starting a multicamera system. Then, if there is a separate server in use, it must measure the network delay together with the recorder, which delay the server stores in the memory for the recorder to fetch. If in a multicamera system, such as an advantageous embodiment of the invention, the recorders signal with each other without a separate server and are thus a part of a formed data network, they measure the delay between each other and set this delay as the value of the network part travelling between them. The synchronization takes place by transmitting to each device the earliest possible time and the largest possible network delay by searching the longest weighted path from the data network (between the recorders) or by searching an appropriate upper limit for it. If no specific value is found for the longest path, in this connection it is also possible to use evaluation. Evaluation does not deface the network delay, because the most important thing is that the estimated value is the same for all recorders.

The synchronization can also be performed immediately after the first device C1 is triggered, which increases the delay between pressing the button and taking the picture. When the synchronization is performed, a common time and common latency is provided for all recorders C1, C2, C3, C4.

When the time stamp in the devices has expired, the imaging performed by all recorders takes place substantially simultaneously. This means that the camera sensor of each recorder performs the imaging independently and the target of each recorder is stored directly in their own memory.

As a result of the multicamera system MC is provided a group of images I1, I2, I3, I4 that are “the same” time-wise. These images with their time stamps are transmitted further to that one or more device, which is determined as data collector. This colleting device can be a device that has functioned as a trigger or some other device provided with a camera sensor or without one. Each recorder transmits the image it has taken with its time stamp to that neighbouring device which is the closest to the collecting device, or to that device which is predetermined as a receiver. In addition, each imaging device transmits images taken by others with their time stamps closer to the collecting device when the device is between the recorder that has imaged and the collecting device. The device collecting image data stores all the images it has received with their time stamps. Those images that have the same time stamp belong together and they are handled application-specifically. After this, the system performs a situation-specific image handling for the images it has taken.

In the following, some different embodiments and applications for the system according to the invention are presented. It should be understood that the following situations are only some examples of applying the invention and that other examples will of course be possible and will vary according to the needs and ideas of the users.

1. Individual Target, Several Persons Taking the Picture on the Same Side of the Target

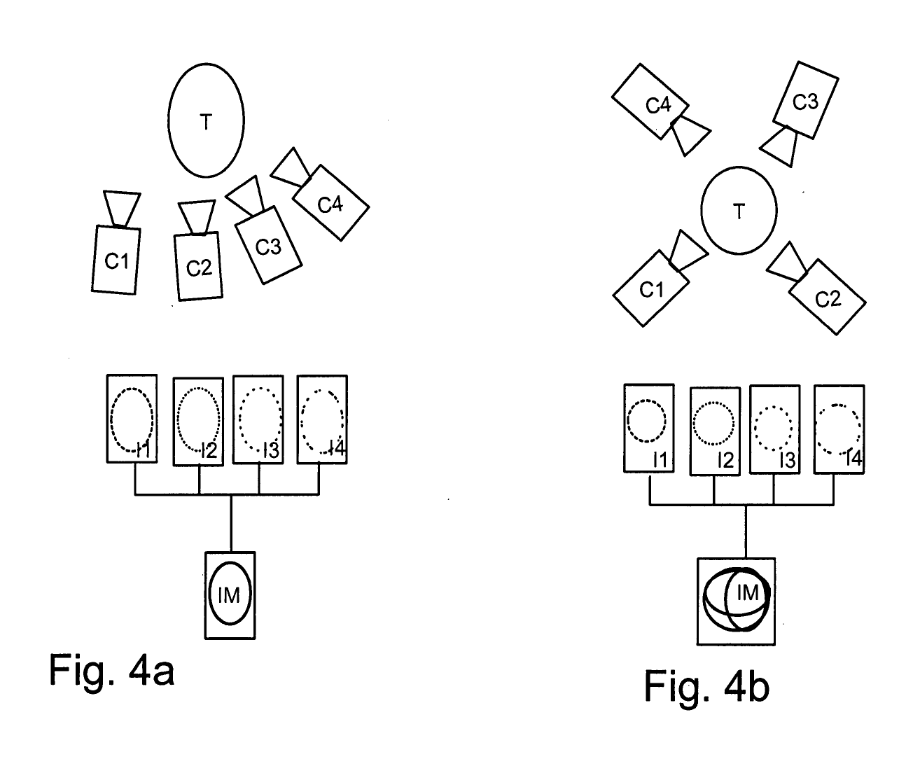

All the recorders C1, C2, C3, C4 are focused on the target T according to FIG. 4a. The persons taking the picture are located on one side of the target T, in which case the image captured of the target is formed along with a joint triggering on each recorder substantially from the same angle and with the same appearance. When desired, images I1, I2, I3, I4 can be combined in order to form a larger and more focused image IM.

2. Three-Dimensional Imaging, Persons Taking the Picture Around an Individual Target

Several recorders C1, C2, C3, C4 surround the target T according to FIG. 4b. Along with the joint imaging, each recorder takes an image I1, I2, I3, I4, in which case an image IM combined of these images is formed as a three-dimensional model.

3. Several Possible Targets, Several Recorders

a) Recorders in the same space
Along with joint imaging, it is easy to provide snapshots of the target changing in perspective. An example is a football game where the scoring moment can be imaged from several different angles together with the images of the faces of the spectators and coaches.

b) Recorders far away from each other
Along with joint imaging, it is easy to share image information on where each person taking the picture was at a certain moment of time. An example is a global network service, where the images from different recorders and different locations are gathered on one page. The service sends imaging requests to different terminals, in which case images are received from several locations at a certain moment of time, in which case a globe that can be easily scanned is formed right away.

In each of these examples, the method according to the invention can be utilized as such. Other examples require more image processing than others, but that is independent of the invention.

It is to be noted that the method can be applied also in connection with other media, such as video (short video clips) and audio (spatial and wide audio). In addition the method can be applied also in connection to other media that is in electric (digital) form, such as radar scans, infrared, ultrasound, x-ray images (images beyond visible wavelengths) or other measurements probing the target. It is also to be noted that the method according to the invention connected with some known positioning method expands the application field of the invention further. The positioning method can, for example, be used to facilitate the modelling of the imaged target, for example, when the recorders image the same target but are located within a significant distance of each other. Thus, the locations of the recorders are in addition known.

In global imaging, the images can along with positioning be also tied precisely to certain locations. Without a positioning method, the location is to be concluded roughly by means of a mobile phone network, or left without location data. All the devices receive a common timer from the positioning system, in which case they only need to know how long sending the trigger message to all will take. The reference timer is already known at that stage, and no synchronization is required for it. Only the delay of message sending must still been known. Thus, positioning significantly improves and speeds up the operation and usability of the system. Location information, as well as other necessary additional information about the imaging situation can be stored in connection with the image, in which case, for example, modelling can be implemented more effortlessly.

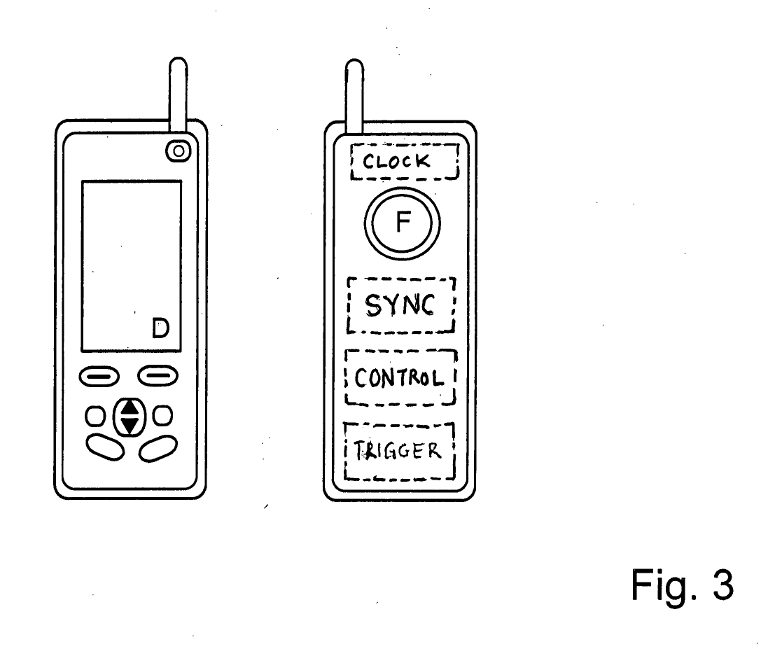

The multicamera system according to the invention can be implemented as a part of the electronic device, for example in a camera or the like. Typically, the electronic device also comprises other functions, such as means for displaying image information to the user, and a processor for controlling the electronic device. A digital camera comprising a camera unit according to the invention can advantageously be implemented in connection with a portable terminal, either as a separate unit or as integrated into the device, in which terminal there are also other functions, such as communication means i. This kind of an example is presented in FIG. 3, where the digital camera is integrated into a mobile phone. There is a camera/viewfinder F on the back of the mobile phone, and the image searched by it is shown on the display D of the mobile phone. Furthermore, the digital camera comprising the camera unit according to the invention may be connected to a communication network (e.g. the Internet), such as WebCam.

It will be evident to anyone of skill in the art that the present invention is not limited solely to the above embodiment, but it can be modified within the scope of the following claims so that the idea of the invention—the operation of several recorders brought on as a result of a wireless command leaving from one recorder—remains unchanged.

1. A capturing method, in which method at least two recorders are controlled to capture substantially simultaneously one target common for the recorders or several targets separate for the recorders, comprising
synchronizing the recorders to a common reference clock, transmitting a triggering message comprising at least a time stamp is transmitted to the recorders via a wireless connection to control the recorders to perform the capturing at the time determined by the time stamp in relation to the common reference clock.

2. The method according to claim 1, wherein the triggering message is formed in one of said at least two recorders.

3. The method according to claim 1, wherein the triggering message comprises information about a maximum delay caused by a time to transmit the time stamp over the wireless connection between the recorders and by a delay time due to functionality of the recorders.

4. The method according to claim 1, wherein the triggering message is transmitted to the recorders by utilizing a wireless local area network or a wireless mobile communication network.

5. The method according to claim 1, wherein information captured according to the method with the recorders is gathered together for further processing.

6. The method according to claim 1, wherein a physical location of at least one recorder is determined by means of a positioning system.

7. The method according to claim 1, wherein additional information concerning capturing the target or targets is stored in connection with the record formed in the capturing.

8. The method according to claim 1, wherein the record formed in the capturing the target or targets is one of the following or a combination of them: a still image, a moving image, a sound.

9. A multi-recorder system comprising at least two recorders, which are arranged to be controlled to capture substantially simultaneously one target common for the recorders or several targets separate for the recorders, wherein the system comprises at least synchronizing means for synchronizing the recorders to a common reference clock, and
control means for transmitting a triggering message comprising at least a time stamp to the recorders via a wireless connection
to control the recorders to perform capturing at a time determined by the time stamp in the relation to the common reference clock.

10. The multi-recorder system according to claim 9, wherein the triggering message is arranged to be formed in one of said at least two recorders.

11. The multi-recorder system according to claim 9, wherein the triggering message is arranged to comprise information on a maximum delay caused by a time to transmit the time stamp between the recorders and by a delay time due to functionality of the recorders.

12. The multi-recorder system according to claim 9, wherein the triggering message is arranged to be transmitted to the recorders by utilizing a wireless local area network or a wireless mobile communication network.

13. The multi-recorder system according to claim 9, wherein the system further comprises means for gathering together the information captured with the recorders for further processing.

14. The multi-recorder system according to claim 9, wherein the system comprises means for determining a physical location of at least one recorder by means of a positioning system.

15. The multi-recorder system according to claim 9, wherein the system further comprises means for capturing additional information concerning capturing the target or targets and storing the information in connection with the record.

16. The multi-recorder system according to claim 9, wherein the record formed in the capturing the target or targets is one of the following or a combination of them: a still image, a moving image, a sound.

17. The multi-recorder system according to claim 9, wherein the system is a multicamera system.

18. A terminal for controlling one or more recorders to capture substantially simultaneously one target common for the recorders or several targets separate for the recorders, wherein the terminal comprises at least
synchronizing means for synchronizing the terminal to a common reference clock shared by the recorders, and
control means for transmitting a triggering message comprising at least a time stamp to the recorders via a wireless connection to control the recorders to perform capturing at the time determined by said time stamp in relation to the common reference clock.

19. The terminal according to claim 18, wherein the terminal further comprises a camera sensor and is itself arranged to operate as one of the recorders.

20. The terminal according to claim 18, wherein the terminal is arranged to form the triggering message by taking into account a maximum delay between the terminal and the recorders caused by a mutual data transfer with the recorders and by a delay due to functionality of the recorders.

21. The terminal according to claim 18, wherein the terminal is a mobile communication device.

22. A recorder unit, which comprises means for capturing a target based on a triggering message received by the unit, wherein the unit comprises at least
synchronizing means for synchronizing the unit to a common reference clock shared with at least one other device,
reception means for receiving via a wireless connection a triggering message that comprises at least a time stamp, and
triggering means for capturing the target at the time determined by the time stamp comprised by the triggering message in relation to the common reference clock.

23. The unit according to claim 22, wherein the recorder unit is arranged in a mobile communication device.

24. The unit according to claim 23, wherein the recorder unit is arranged to capture one of the following records or a combination of them: a still image, a moving image, a sound.

25. The unit according to claim 24, wherein the recorder unit is arranged in a camera phone.

26. A computer software product, comprising computer-readable commands recorded on a memory media, the commands arranged to implement a capturing method, where at least two recorders are controlled to perform the capturing substantially simultaneously of one target common for the recorders or several targets separate for the recorders, wherein said software commands comprise at least
commands for receiving in a recorder via a wireless connection a triggering message comprising at least a time stamp to control the recorder to perform capturing at a time determined by said time stamp in relation to a common reference clock with which the recorders have been synchronized.

27. The computer software product according to claim 26, wherein the product is arranged to be run in a mobile communication device arranged as a recorder.

28. A computer software product, comprising computer-readable commands recorded on a memory media, the commands arranged to implement a capturing method, where at least two recorders are controlled to perform the capturing substantially simultaneously of one target common for the recorders or several targets separate for the recorders, wherein said software commands comprise at least
commands for transmitting to a recorder via a wireless connection a triggering message comprising at least a time stamp to control the recorder to perform capturing at the time determined by said time stamp in relation to a common reference clock with which the recorders have been synchronized.

29. The computer software product according to claim 28, wherein the product is arranged to be run in a mobile communication device arranged as a triggering device.
